(19) United States
(12) Patent Application Publication
(10) Pub. No.: US 2010/0153261 A1
(43) Pub. Date: Jun. 17, 2010

(54) System and method for providing transaction classification

(76) Inventors: Benny Tseng, Brookfield, CT (US); Christopher Byrd, New Milford, CT (US); Dirk Flachbart, Brookfield, CT (US); Richard Wells, Roseville, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/314,480

(22) Filed: Dec. 11, 2008

(51) Int. Cl. G06Q 40/00; G06F 17/00; G06Q 10/00

(52) U.S. Cl. 705/39; 705/35; 707/E17.005; 707/E17.09

(57) ABSTRACT

A method and system provide transaction classification. The method and system provide an extensible markup language (XML) representation of real transaction instance data collected from a data collection agent, provide an XML based rule engine that enables a user to define a classification rule for classifying the real transaction instance data, and provide a user interface to enable the user to navigate among the real transaction instance data to define the classification rule.

### BACKGROUND

In the world of business technology optimization (BTO), and specifically business service management (BSM), attempts are being made to provide integrated management solutions focusing on business transactions. Traditionally vendors have provided disjoint solutions that treat the business world (i.e., business processes) and information technology (IT) world (i.e., applications and system infrastructure components) separately. However, users, i.e., customers, find it hard to correlate the business processes with the supporting applications and system infrastructure components.

### BRIEF DESCRIPTION OF THE DRAWINGS

Exemplary embodiments of system and method for providing transaction classification through real transaction instance data modeling and analysis will be described in detail with reference to the following figures, in which like numerals refer to like elements, and wherein:

FIG. 1 is a block diagram illustrating an exemplary system for providing transaction classification through real transaction instance data modeling and analysis;

FIG. 2 illustrates an exemplary transaction classification user interface provided by the exemplary system of FIG. 1 showing sample XML classification rules;

FIG. 3 is a flow chart illustrating an exemplary method for providing transaction classification through real transaction instance data modeling and analysis; and

FIG. 4 illustrates exemplary hardware components of a computer that may be used in connection with the method for providing transaction classification through real transaction instance data modeling and analysis.

### DETAILED DESCRIPTION

Business transaction management (BTM) uses real transaction instance data as the link between the business world (i.e., business processes) and the information technology (IT) world (i.e., applications and system infrastructure components). By efficiently categorizing individual business transaction instances, a high level business process model and low level application and system infrastructure components can be linked through business transaction classes (i.e., categories). BTM works with both business process management (BPM) and composite application management (CAM) and ties them together with statistics among the different monitoring layers (e.g., high level business data or low level supporting infrastructure runtime health statistics). In this way, business key performance indicators (KPI) data can, for instance, be enriched with transaction and infrastructure runtime status and metrics.

Efficient transaction classification is important to business service management (BSM) because the transaction classification bridges the high level business process model and the low level IT infrastructure model. An exemplary system and method for providing transaction classification categorize enterprise business transactions by evaluating business process data and IT infrastructure data available at one or more check points along a transaction flow path.

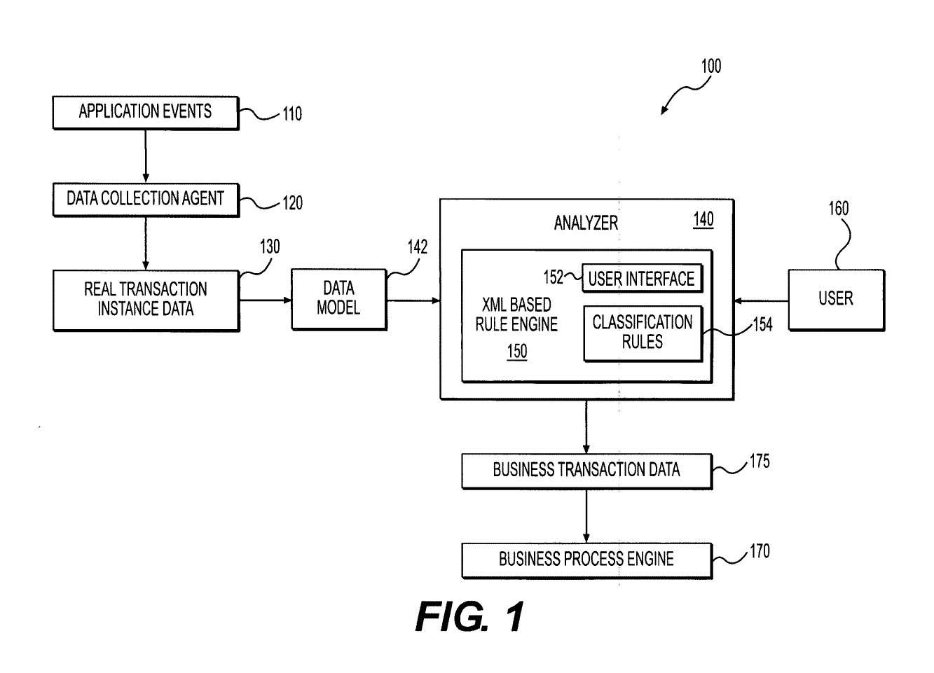

FIG. 1 is a block diagram illustrating an exemplary system 100 for providing transaction classification through real transaction instance data modeling and analysis. The system 100 utilizes real transaction instance data 130, i.e., real transaction event data, collected from a data collection agent 120, such as the HP TransactionVision product, which is a product that monitors application events 110 and collects the real transaction instance data 130. Such a system is described in detail in U.S. Pat. No. 7,003,781.

After the real transaction instance data 130 is collected by the data collection agent 120, the system 100 uses a data model 142 to provide an extensible markup language (XML) representation of the collected real transaction instance data 130. XML is a general-purpose specification for creating custom markup language. While the raw data coming from data collection agent 120 may be of a variety of formats (e.g., proprietary, binary, XML), the system 100 employs a Java™ bean processing framework that allows the user 160 to develop computer program code for converting and optimizing the real transaction instance data 130 into a uniform XML format. As a result, the user 160 can access and analyze the real transaction instance data 130 in a format that is common to a number of different environments. Example of environments include IBM WebSphere Application Server®, BEA WebLogic Application Server®, Microsoft.NET®, IBM mainframe CICS (Customer Information Control System)®, IBM mainframe Information Management System (IMS), IBM WebSphere MQ®, TIBCO EMS®, and SONIC MQ® asynchronous messaging environment running on IBM mainframe zOS platform, various Unix®, and Microsoft Windows® platforms.

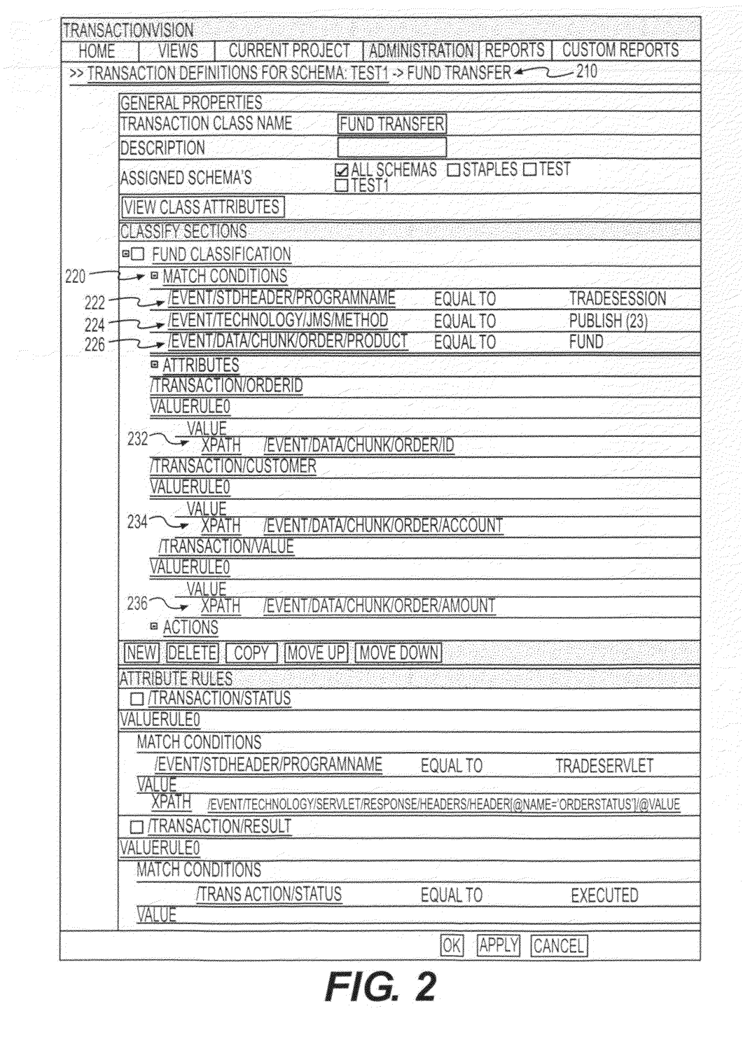

The system 100 provides an analyzer 140 that includes an XML based rule engine 150, i.e., expert system, to provide transaction classification of the collected real transaction instance data 130. The system 100 provides a user interface 152 (also shown as 200 in FIG. 2) so that a user 160 may use the XML based rule engine 150 to define or create one or more classification rules 154 to classify the real transaction instance data 130. Since the real transaction instance data 130 is represented in XML, the classification rules can be constructed with matching conditions expressed in the XML format. Such classification rules 154 are flexible to identify and can refer to any business process data or IT infrastructure data along any transaction/event flow trace points through an XML based access path, i.e., access syntax, such as the XML path language, i.e., XPath, shown in FIG. 2 as 232, 234, 236. A transaction/event flow trace point refers to a particular repeatable execution point and associated running state in a software application life cycle. The running state reflects the current processing status of an application at the execution point, and can contain one or more name-value pairs based on business or IT infrastructure data. Events are objects created by a monitoring agent (e.g., The HP TransactionVision sensors) that captures the running state at the indicated execution point. For example, events can be generated based on a Java™ class method call, while the state data is generated from the different call parameters and single return result of the method call. When encoding the different pieces of state data into the event, such data can be assembled into an XML document. Alternatively, a mapping table containing individual mapping between each piece of state data and an XML path based signature (e.g., /Event/Data/MyAccountNumber) can be defined. In either case, any piece of state data can be identified and referred to using the XML XPath Language, which is a language for selecting nodes from an XML document. In addition, XPath may be used to compute values (e.g., strings, numbers, or Boolean values) from the content of an XML document.

Creating the classifying rules 154 may be a manual process performed by the user 160, i.e., customer or human designer, based on a service level agreement (SLA). The system 100 provides a user interface 154 assisting the user 160 to navigate among the real transaction instance data 130, inspect individual business process data and IT infrastructure data, and create the classification rules 154. The classification rules may automatically generate the XML based access path to critical business process data, such as business transaction data or business specific information. The user 160 works with the real transaction instance data 130 instead of relying on personal knowledge and interpretation of the overall system, which can be error prone.

FIG. 2 illustrates an exemplary transaction classification user interface 200 showing sample XML classification rules. A business transaction class “Fund Transfer” 210 is created. The user interface 200 allows a customer to define a rule, which contains matching conditions 220, for classification. For example, the rule provides that if an incoming event (a) comes from program “TradeSession” 222, (b) invokes a Java™ message service (JMS) method “publish” 224, and (c) contains business data at XPath “/Event/Data/Chunk/Order/Product” equals to “FUND” 226, the associated real transaction instance data is classified as a “Fund Transfer” 200. As another example, the customer may classify a mainframe transaction trace point denoting the type of trade being executed (e.g.:/Event/Data/BankTrade/tradeType=“10 year Treasury”). These examples show that both business process data and IT infrastructure data are used for classification purposes and that the user interface, such as that illustrated in FIG. 2 enables the user to inspect business process data and information technology (IT) infrastructure data concurrently.

The XML based rule engine 150 of the system 100 also allows the user 160 to define or create a specific type of rule to extract business transaction data 175, i.e., business specific information, from the real transaction instance data 130 and publish the extracted business transaction data 175 to a business process engine 170 to provide meaningful information to a business process manager. Specifically, the system 100 provides an event model (not shown) that allows the user 160 to establish a mapping between business process data and the business transaction data 175. An XML database mapper (XDM) may be used for configuration time mapping from an XML format of the data model to physical relational database table columns. For example, a complex stock trade business process can contain multiple steps, such as fund availability checking, stock price quote checking, and trade execution. Each of the business process steps may be implemented by a specific business transaction. Examples of business transaction data, i.e., business specific information, include a bank account number and a transaction amount of a fund transfer. Another type of information, referred to as IT infrastructure information, is regarding the status of the actual software system that implements the business transactions. A business process manager, i.e., high level management, typically prefers to see the business transaction data. The system 100 allows both the business transaction data and the IT infrastructure data to be published to the business process engine 170 and to be accessed by the business process manager. The HP Business Process Insight (BPI) software is an exemplary product for modeling and tracking enterprise business process data flow which may serve as business process engine 170.

To accommodate complex classification matching conditions, the user 160 can alternatively bypass the standard XML based rule engine 150 and develop custom Java™ code to implement the classifying conditions.

The system 100 further allows verification of the transaction classification by checking against real transaction instance data 130. Any unclassified real transaction instance data may be reported automatically, and can be subsequently inspected and categorized, thus refining the classification model.

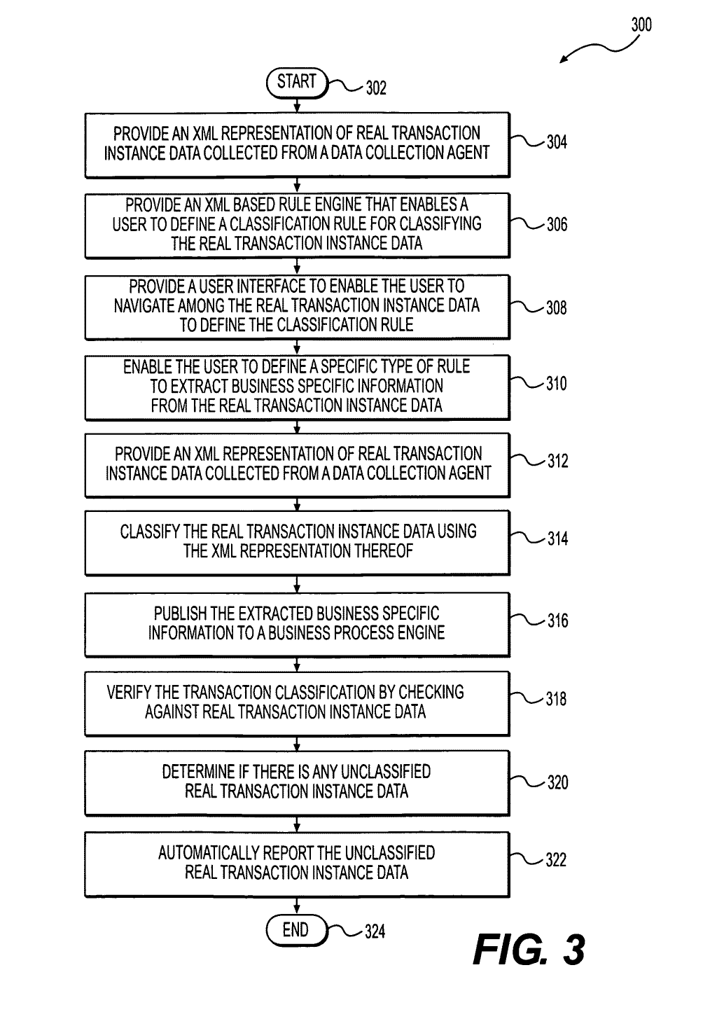

FIG. 3 is a flow chart illustrating an exemplary method 300 for providing transaction classification through real transaction instance data modeling and analysis. The exemplary method 300 starts 302 by providing an XML representation of real transaction instance data collected from a data collection agent (block 304). The method 300 then provides an XML based rule engine that enables a user to define a classification rule for classifying the real transaction instance data (block 306) and provides a user interface to enable the user to navigate among the real transaction instance data to define the classification rule (block 308). The user interface may enable the user to inspect business process data and information technology (IT) infrastructure data. The classification rule automatically generates an XML based access path to business process data. The XML based rule engine enables the user to define a specific type of rule to extract business specific information from the real transaction instance data (block 310). The method provides an XML representation of real transaction instance data collected from a data collection agent (block 312) and classifies the real transaction instance data using the XML representation thereof (block 314).

The method 300 then publishes the extracted business specific information to a business process engine (block 316). The business specific information includes one or more of a bank account number and transaction amount of a fund transfer. The method 300 may verify the transaction classification by checking against real transaction instance data (block 318) by determining if there is any unclassified real transaction instance data (block 320) and automatically reporting the unclassified real transaction instance data (block 322) so that the user can create further classification rules. The method 300 ends at block 324.

The system 100 and method 200 are non-intrusive to customer applications, i.e., do not require any configuration changes in the monitored enterprise environment because there is no need to inject classification information. The manual configuration process may be less error prone since the customer, i.e., rule designer, works with real transaction instance data instead of relying on personal knowledge and interpretation of the overall system. The transaction classification user interface helps the customer to navigate and inspect transaction data in an efficient manner. The rules are built and executed against the collected real transaction instance data and are flexible to work with any customer data because the rules can work on any business data or IT infrastructure data available on any check points on the overall transaction flow path. The system and method work with an open and flexible standard, such as XML. The data model and rule engine framework can be implemented in a generic way and can be extended to manage new data sources and models. The system and method facilitate real transaction information exchange between the business process data and the business transaction data, thus providing real time feedback to business process managers via a suitable tool such as the HP Business Process Insight (BPI) software product.

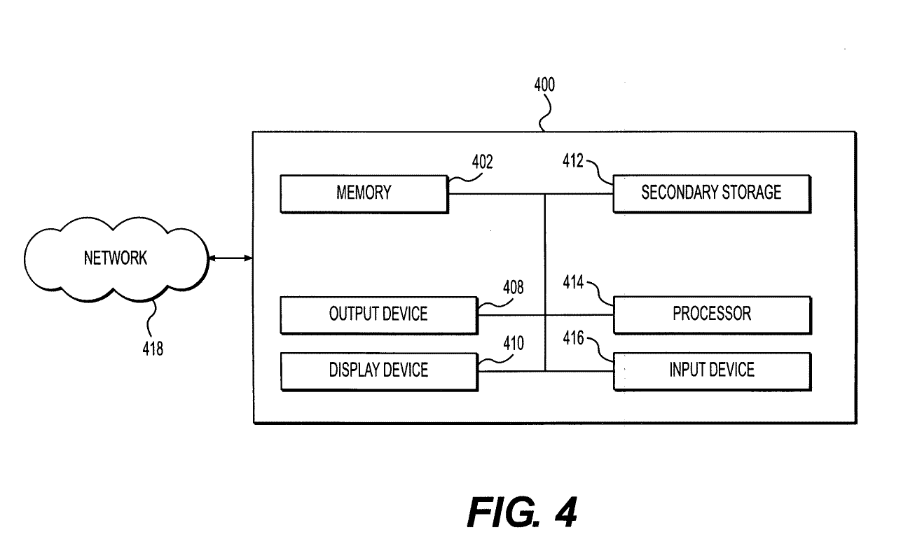

FIG. 4 illustrates exemplary hardware components of a computer 400 that may be used in connection with the method for providing transaction classification through real transaction instance data modeling and analysis. The computer 400 includes a connection with a network 418 such as the Internet or other type of computer or telephone network. The computer 400 typically includes a memory 402, a secondary storage device 412, a processor 414, an input device 416, a display device 410, and an output device 408.

The memory 402 may include random access memory (RAM) or similar types of memory. The secondary storage device 412 may include a hard disk drive, floppy disk drive, CD-ROM drive, or other types of non-volatile data storage, and may correspond with various databases or other resources. The processor 414 may execute information stored in the memory 402, the secondary storage 412, or received from the Internet or other network 418. The input device 416 may include any device for entering data into the computer 400, such as a keyboard, keypad, cursor-control device, touch-screen (possibly with a stylus), or microphone. The display device 410 may include any type of device for presenting a visual image, such as, for example, a computer monitor, flat-screen display, or display panel. The output device 408 may include any type of device for presenting data in hard copy format, such as a printer, or other types of output devices including speakers or any device for providing data in audio form. The computer 400 can possibly include multiple input devices, output devices, and display devices.

Although the computer 400 is shown with various components, one skilled in the art will appreciate that the computer 400 can contain additional or different components. In addition, although aspects of an implementation consistent with the method for providing transaction classification through real transaction instance data modeling and analysis are described as being stored in memory, one skilled in the art will appreciate that these aspects can also be stored on or read from other types of computer program products or computer-readable media, such as secondary storage devices, including hard disks, floppy disks, or CD-ROM; or other forms of RAM or ROM. The computer-readable media may include instructions for controlling the computer 400 to perform a particular method.

While the system and method for providing transaction classification through real transaction instance data modeling and analysis have been described in connection with an exemplary embodiment, those skilled in the art will understand that many modifications in light of these teachings are possible, and this application is intended to cover variations thereof.

What is claimed is:

1. A method for transaction classification, the method being implemented on a computer including a processor and an input device, the method comprising:
using the processor to provide an extensible markup language (XML) based rule engine that enables a user to define a classification rule for classifying the real transaction instance data into different classes;
providing a user interface to enable the user to navigate among the real transaction instance data to define the classification rule using the input device;
using the processor to provide an XML representation of real transaction instance data collected from a data collection agent;
classifying the real transaction instance data using the XML representation thereof.

2. The method of claim 1, wherein the user interface enables the user to inspect business process data and information technology (IT) infrastructure data concurrently to define the classification rule.

3. The method of claim 1, wherein the classification rule generates an XML access path to business process data within the real transaction instance data.

4. The method of claim 1, wherein the XML based rule engine enables the user to define a specific type of rule to extract business specific information from the real transaction instance data.

5. The method of claim 4, further comprising publishing the extracted business specific information to a business process engine.

6. The method of claim 1, wherein the business specific information includes one or more of a bank account number and transaction amount of a fund transfer.

7. The method of claim 1, further comprising verifying the transaction classification by checking against the real transaction instance data.

8. The method of claim 7, wherein the verifying step further comprises:
determining if there is any unclassified real transaction instance data; and
automatically reporting the unclassified real transaction instance data so that the user can create further classification rules.

9. The method of claim 1, wherein the user can develop a custom Java™ code to implement the transaction classification.

10. A system for transaction classification, the system being implemented on a computer including a memory and a processor, the system comprising:
a data model stored in the memory that can be used to provide an extensible markup language (XML) representation of real transaction instance data collected from a data collection agent;
an XML based rule engine executed by the processor, the XML based rule engine being arranged to enable a user to define a classification rule for classifying the real transaction instance data into different classes; and
a user interface for enabling the user to navigate among the real transaction instance data to define the classification rule.

11. The system of claim 10, wherein the user interface enables the user to inspect business process data and information technology (IT) infrastructure data concurrently to define the classification rule.

12. The system of claim 10, wherein the classification rule can automatically generate an XML based access path to business process data within the real transaction instance data.

13. The system of claim 10, wherein the XML based rule engine is arranged to enable the user to define a specific type of rule to extract business specific information from the real transaction instance data.

14. The system of claim 13, wherein the XML based rule engine is adapted to publish the extracted business specific information to a business process engine.

15. The system of claim 10, wherein the XML based rule engine is adapted to verify the transaction classification by checking against the real transaction instance data.

16. The system of claim 15, wherein the XML based rule engine is adapted to verify the transaction classification by determining if there is any unclassified real transaction instance data, and automatically reporting the unclassified real transaction instance data so that the user can create further classification rules.

17. A computer readable medium providing instructions for providing transaction classification, the instructions comprising instructions for:
providing an extensible markup language (XML) representation of real transaction instance data collected from a data collection agent;
providing an XML based rule engine that enables a user to define a classification rule for classifying the real transaction instance data into different classes; and
providing a user interface to enable the user to navigate among the real transaction instance data to define the classification rule.

18. The computer readable medium of claim 17, wherein the XML based rule engine enables the user to define a specific type of rule to extract business specific information from the real transaction instance data.

19. The computer readable medium of claim 17, further comprising instructions for verifying the transaction classification by checking against the real transaction instance data.

20. The computer readable medium of claim 19, wherein the instructions for verifying step further comprise instructions for:
determining if there is any unclassified real transaction instance data; and
automatically reporting the unclassified real transaction instance data so that the user can create further classification rules.
